(19) United States
(12) Patent Application Publication
(10) Pub. No.: US 2013/0238527 A1
(43) Pub. Date: Sep. 12, 2013

(54) METHODS FOR STRATEGIC ASSET ALLOCATION BY MEAN REVERSION OPTIMIZATION

(71) Applicant: RIVERFRONT INVESTMENT GROUP, LLC, Richmond, VA (US)

(72) Inventor: Michael Jones, Midlothian, VA (US)

(73) Assignee: Riverfront Investment Group, LLC, Richmond, VA (US)

(21) Appl. No.: 13/871,155

(22) Filed: Apr. 26, 2013

Related U.S. Application Data
(63) Continuation-in-part of application No. 13/072,055, filed on Mar. 25, 2011.

(51) Int. Cl. G06Q 40/06

(52) U.S. Cl. CPC G06Q 40/06
USPC 705/36 R

(57) ABSTRACT

A computer implemented method of determining the optimal asset allocation strategy for an investment portfolio is disclosed. The optimization methodology is premised on computerized mathematical models that relate the distance from the long-term market trend at the beginning of historical periods to the returns investors ultimately receive over subsequent periods. The method incorporates a tendency of asset prices to revert to their long term trend over longer investment horizons. Applying this concept to optimizing asset allocation strategies required building software for configuring a computer to replicate this mean-reverting behavior within an optimization process and determine the distribution of expected returns from a current distance from trend.

### CROSS REFERENCE TO RELATED APPLICATIONS

This Application claims priority to and benefit under 35 USC §120 of U.S. patent application Ser. No. 13/072,055, of the same title, filed Mar. 25, 2011, which is hereby incorporated by reference as if fully set forth below.

### BACKGROUND

1. Field of the Invention

Embodiments of the present invention relate to a method for determining the optimal asset allocation strategy for an investment portfolio. The optimization methodology is based on mathematical models that, for equity and commodity asset classes, relate the distance from the long-term market trend at the beginning of historical periods to the returns investors ultimately receive over subsequent periods, incorporating the tendency of asset prices to revert to their long term trend over longer investment horizons. Fixed income asset class returns can be calculated as a function of the starting yield of the asset class and the mathematical relationship between its future price and simulated changes in treasury interest rates and risk premia over treasury rates. Applying these concepts to optimizing asset allocation strategies can be implemented using software that can replicate this mean-reverting behavior, realistic simulation of potential interest rate environments, and the relationship between the rate of mean reversion and interest rates within an optimization process.

2. Background of Related Art

Investment portfolios are typically based upon an asset allocation strategies tailored to the investment objective and risk tolerance of the investor. Determining the correct asset allocation strategy for an investor can be difficult. As with virtually every aspect of financial-market analysis, no consensus currently exists as to the “correct” way to calculate expected returns and determine other capital market assumptions (CMAs). Industry standard methodologies take on various forms but are generally built upon the pioneering work of Nobel Laureate Harry Markowtiz. These models of expected return assume that equity market returns follow a “random walk.” Under random walk theory, market prices perfectly incorporate all known information and therefore the current valuation level of the market has no impact on expected returns and downside risks. As such, whether equity prices have been inflated by a speculative bubble (as in 1999) or deflated by a deep bear market (as in early 2009), the expected long-term return for large cap stocks remains virtually unchanged. Similarly, whether starting interest rates are extremely high (thus providing high interim cash flow and appreciable probability of subsequent interest rate declines and associated capital gains) or starting interest rate are close to zero (minimizing interim cash flow and providing extremely low probability of subsequent declines), the expected returns for fixed income asset classes are assumed to approximate long term average levels. Thus under random walk assumptions, the best estimate for future market returns is the average annual market return over some historical period.

In addition to defining how expected returns should be defined and calculated, Markowtiz also established the industry standard definition of risk. To Markowitz (and most asset allocation models), risk is defined as the standard deviation, or volatility, of annual returns. As with expected returns, risk is assumed to be unconnected to market valuation levels. By combining asset classes with less than perfect correlation into the portfolio, Markowitz theorized that portfolio returns could be improved without increasing the standard deviation of portfolio returns (higher return for the same degree of risk). Thus, industry standard optimization processes require a set of capital market assumptions (CMAs) defined as an expected average annual return, volatility of that return and the correlation of every asset class in the optimization to every other asset class (a covariance matrix).

The expected returns, volatility estimates, and a covariance matrix produced by the above process (or any of a myriad of other processes that vary in details but build upon similar theories) are input into a mean variance optimization tool. Mean variance optimization (MVO) uses the input estimates to calculate the combination of asset classes that maximizes expected 1-year (or 1 period) returns for each level of potential portfolio volatility.

A variation on the MVO methodology is resampling optimization, in which the each input CMA is assumed to be drawn from a distribution of potential CMAs. A resampling process uses Monte Carlo simulation to take this uncertainty in CMA values into account within the optimization. However, both mean variance optimization and resampling methodologies build upon the core concepts of optimizing random one period returns subject to a level of risk measured by the standard deviation of one period returns.

There exists a need for an improved method of determining the optimal asset allocation for an investment portfolio. There further exists a need for a method of better measuring portfolio risk and therefore the optimal tradeoff between risk and potential return. It is to such a method that embodiments of the present invention are primarily directed.

### SUMMARY

Embodiments of the present invention are directed to a computer implemented method of setting an asset allocation strategy comprising calculating multiple potential long term inflation environments using modified Monte Carlo methods that can account for the substantial autoregressive tendencies in historical inflation data. The simulated inflation environment can be used along with other optional inputs (e.g., known guidance about Federal Reserve policy, imposition of “arbitrage free” conditions, etc.) to estimate a potential distribution of interest rates for various fixed income asset classes premised upon the historical relationship of interest rates of various maturities to the rate of inflation. Finally, a current difference can be calculated between a current value of an equity or commodity asset class and the current value predicted by a historic trend line of the value of the asset class for multiple asset classes.

The returns of a particular equity or commodity asset class have responded somewhat predictably from points in history having similar differences from the historic trend line and similar inflation and interest rate environments, while fixed income returns are a deterministic outcome of the starting interest rate and interest rate changes observed during the investment horizon. Therefore, it is beneficial to develop a distribution of expected returns based upon a simulation of inflation and interest rates for multiple fixed income asset classes and the current difference from trend for multiple equity and commodity asset classes. Embodiments of the method may comprise estimating an expected distribution of asset class future values for multiple investment periods, wherein the expected asset class future values are derived from historical responses of fixed income asset class to the inflation and interest rate environment and the historical responses of equity and commodity asset classes to the current difference from trend for each investment period and the degree of mean reversion historically observed in each asset class. Depending upon the asset class, the degree of mean reversion is also a function of the inflation and interest rate environment.

Historically, equity and commodity asset classes have responded somewhat predictably to market conditions, with periods starting well below the long term trend tending to produce above average returns and periods beginning well above the long term trend producing below average returns as markets revert to their long term trend. However, due to random walk theory asset allocation strategies tend to be derived using long term average capital market assumptions, with capital market assumptions remaining the same irrespective of market valuation and with optimization techniques that never vary expected returns. Similarly, fixed income asset class returns are simulated assuming a distribution around long term average returns, and do not incorporate the starting interest rate environment or the tendency of negative fixed income returns to improve prospects for subsequent positive returns as declining bond prices drive interest rates higher. This is a weakness of current models and adjustment of capital market assumptions would refine asset allocation strategy methods. Therefore, embodiments of the computer implemented method of setting an asset allocation strategy may comprise calculating expected distribution of asset class future values by a Monte Carlo method for multiple asset classes using capital market assumptions premised on the initial interest rate for fixed income asset classes, the distance from trend for each equity and commodity asset class, the potential default environments for credit sensitive fixed income asset classes and wherein the capital market assumptions of a subsequent Monte Carlo trial are recalculated based upon the results of the previous Monte Carlo trial.

The invention is directed to a computer implemented method of setting an asset allocation strategy for an investment portfolio. A computer may be configured to calculate multiple potential long term inflation environments using modified Monte Carlo methods that account for the substantial autoregressive tendencies in historical inflation data; and

Uses the simulated inflation environment to estimate a potential distribution of interest rates for treasury obligations of various maturities, taking into account known guidance about future Federal Reserve interest rate policy and assuming a probability distribution around potential changes in said guidance, the historical correlation between the inflation rate, Fed policy and longer maturity interest rates, a random component simulated by Monte Carlo methods and, as an optional input, the drift in future interest rates necessary to maintain arbitrage free conditions within the simulation; and

calculates a current difference from trend between a current value of an asset class and the current value predicted by a historic trend line of the value of the asset class for multiple equity and commodity asset classes; and

estimates an expected distribution of equity and commodity asset class future values for multiple investment periods, wherein the expected asset class future values are derived from historical responses of the asset class to the current difference from trend for each investment period and the degree of mean reversion historically observed in each asset class, and incorporating into these mean reversion calculations the historical impact of the interest rate and inflation environment on the rate of mean reversion, with a random component simulated by Monte Carlo methods; and

calculates a potential distribution of risk premia over treasury obligation yields for various classes of fixed income instruments, basing these calculations upon the historical relationship between these risk premia and inflation, the interest rate differential between treasuries of different maturity, the returns of equity asset classes, and a random component simulated by Monte Carlo methods; and

estimates an expected distribution of fixed income asset class future values for multiple investment periods, wherein the expected asset class future values are calculated as a function of the starting yield of the asset class and the mathematical relationship between its future price and simulated changes in treasury interest rates and risk premia over treasury rates for that asset class, adjusting these returns for credit sensitive fixed income asset classes through models of potential default that relate levels of default to other elements of the simulation (inflation, interest rates, equity returns) and a random component simulated by Monte Carlo methods.

A computer may be configured to use these distribution of expected future returns for various the asset classes to calculate expected future value for multiple investment periods, calculating the expected future value after a second investment period based upon the results of the first investment period, and/or adjusting capital market assumptions based upon the results of the calculation after the end of the first investment period. The computer has associated processing capability and memory storage capable of storing the inputs, intermediate results and the final results of the calculations.

Other aspects and features of embodiments of the method will become apparent to those of ordinary skill in the art, upon reviewing the following description of specific, exemplary embodiments of the present invention in concert with the figures. While features may be discussed relative to certain embodiments and figures, all embodiments can include one or more of the features discussed herein. While one or more particular embodiments may be discussed herein as having certain advantageous features, each of such features may also be integrated into various other of the embodiments of the invention (except to the extent that such integration is incompatible with other features thereof) discussed herein. In similar fashion, while exemplary embodiments may be discussed below as system or method embodiments it is to be understood that such exemplary embodiments can be implemented in various systems and methods.

### BRIEF DESCRIPTION OF THE FIGURES

FIG. 1 depicts the real total return of the stock of large cap companies over a period starting in the year 1926 and ending in the year 2013, in accordance with some embodiments of the present invention.

FIG. 2 is a graph of the ten year return on stocks of large cap companies versus the distance from the long term trend line of large cap stocks at the beginning of the ten year return period, in accordance with some embodiments of the present invention.

FIG. 3 is table comparing the relationship between starting distance from trend and subsequent Real Total Return distributions for large cap stocks across five investment periods, in accordance with some embodiments of the present invention.

FIG. 4 is table comparing the relationship between starting distance from trend and subsequent Real Total Return distributions for large cap stocks across five investment periods, in accordance with some embodiments of the present invention.

FIG. 5 is a graph of the ten year return on 10-year maturity treasury bonds versus the starting interest rate at the beginning of the ten year return period, in accordance with some embodiments of the present invention.

FIG. 6 Further illustrates the impact of starting yield on fixed income returns by charting real returns against the starting yield, in accordance with some embodiments of the present invention.

FIG. 7 is a graph of the relationship between short interest rates and yields on 10-year maturity treasury bonds, in accordance with some embodiments of the present invention.

FIGS. 8-9 are examples of the output of the system, in accordance with some embodiments of the present invention.

FIG. 10 is a graph of the portfolio returns versus potential benchmarks/liabilities for all of the return environments in the simulation, in accordance with some embodiments of the present invention.

### DETAILED DESCRIPTION

Embodiments of the present invention relate to a method for optimizing an asset allocation strategy, which can comprise calculating a simulation of potential inflation and interest rate environments and the difference between a current value of an equity or commodity asset class with a trend line of the historic values of the asset class. This difference between the current value of an asset class and a trend line of the historic values of the asset class can provide an indication of the future return of the asset class and the volatility of the future values. This interest rate simulation provides comparable return estimates for fixed income asset classes.

Historically, if the current value of the asset class is below trend line of the historic values, the value of the asset class has tended rise and, thus, to revert to the trend line. As such, the value of a particular asset class tends to revert to an asset class trend line. In some embodiments, the trend line of historical values can be a linear or can be fitted to a curve using regression analysis, such as a nonlinear regression or a regression with multiple variables, to determine the historic price line, hereinafter “mean trend line.” The trend line can be a multivariable equation, wherein the additional variables can include, for example and not limitation, the associated inflation value or slope of the trend line. In some embodiments, the trend line can be a linear trend line or a logarithmic function.

Realistic simulation of potential inflation environments preferably should account for the tendency of inflation rates in one period to be highly dependent upon the inflation rate of prior periods (autocorrelation). Since inflation rates are unlikely to exhibit the dramatic swings from one to period the next common in asset class returns, the simulation can use one of a number of autocorrelation techniques to create appropriate potential future inflation environments. Although autocorrelated from one period to the next, the simulation should preferably allow for the historical variation in inflation rates and can be allowed to simulate unprecedented inflationary environments.

The inflation environment has a complex and variable impact on the interest rate environment, but is predominantly dependent upon the response of the Federal Reserve Bank (the “Fed”) to changes in the inflation rate. Historical periods during which the Fed targeted interest rates rather than inflation rates (the 1940s and 1970s), for example, showed (1) reduced impact of inflation on short-term interest rates directly controlled by the Fed and (2) a muted impact on longer maturity rates even though these rates are less directly controlled by Fed policy. In contrast, periods in which the Fed proactively and preemptively targeted inflation and changed interest rates as needed to achieve desired inflation target (e.g., the 1920s, 1980s, and 1990s) changing inflation had a much more immediate impact on rates of all maturities.

Thus, accurate simulation of interest rates preferably includes some assumption about Fed policy and the degree to which the Fed will target an interest rate (such as the current target of 0.0% to 0.25% until 2014). Under that assumption, changes in inflation will have a slight impact on rates. If the Fed switches to targeting inflation, on the other hand, then changes in inflation will have a large impact on rates. Such assumptions can take the form of a probability distribution of the Fed policy environment, with the responsiveness of rates to inflation adjusting when there is a likely change in policy environment.

Having established the Fed policy environment and thereby the assumed connection between inflation rates and interest rates, a simulation of potential treasury rates consistent with both the inflation environment and Fed policy environment can be calculated. Various distributional assumptions regarding treasury rates can be made such as, for example, a lognormal assumption. Interest rates for bonds of various maturities (i.e., the yield curve) can be simulated with a plurality of sources of independent movement including, but not limited to, level of rates, slope between short and long rates, and the degree of curvature seen as maturities increase. Each of these characteristics can be simulated with a degree of randomness or alternatively models relating these interconnections can be derived from historical data with deviations from the levels predicted by the models calculated using Monte Carlo methods. In either case, the resulting yield curve can be constrained to adhere to historical limits regarding the interconnection between rates of various maturities.

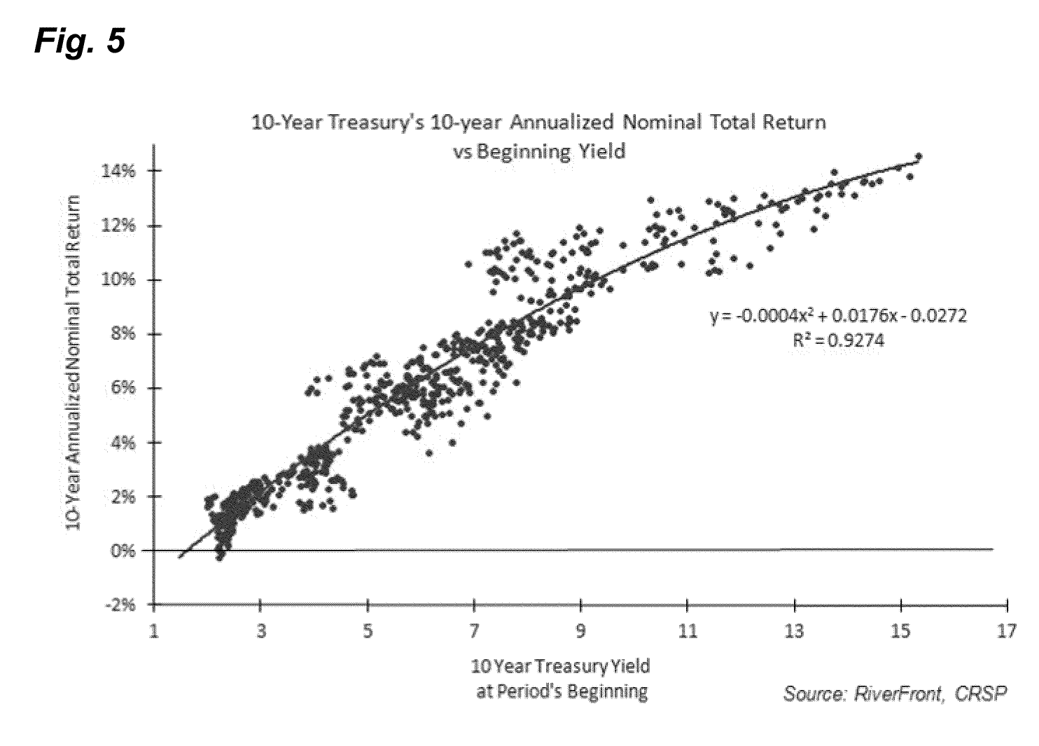

FIG. 5 is a graph of the ten year return on 10-year maturity treasury bonds versus the starting interest rate at the beginning of the ten year return period; and Illustrates that, contrary to random walk theory, the starting yield essentially determines the long term nominal returns of fixed income asset classes, with actual inflation and default experience deducting from the base starting yield to determine real returns net of credit losses. This behavior is precisely replicated in the Mean Reversion Optimization device through simulation of potential interest rate paths rather than bond market returns. By replicating the actual drivers of bond market returns (initial yield/cash flow, change in yield and therefore price, reinvestment of cash flow) a more accurate model of bond market behavior can be simulated than it possible though existing methodologies.

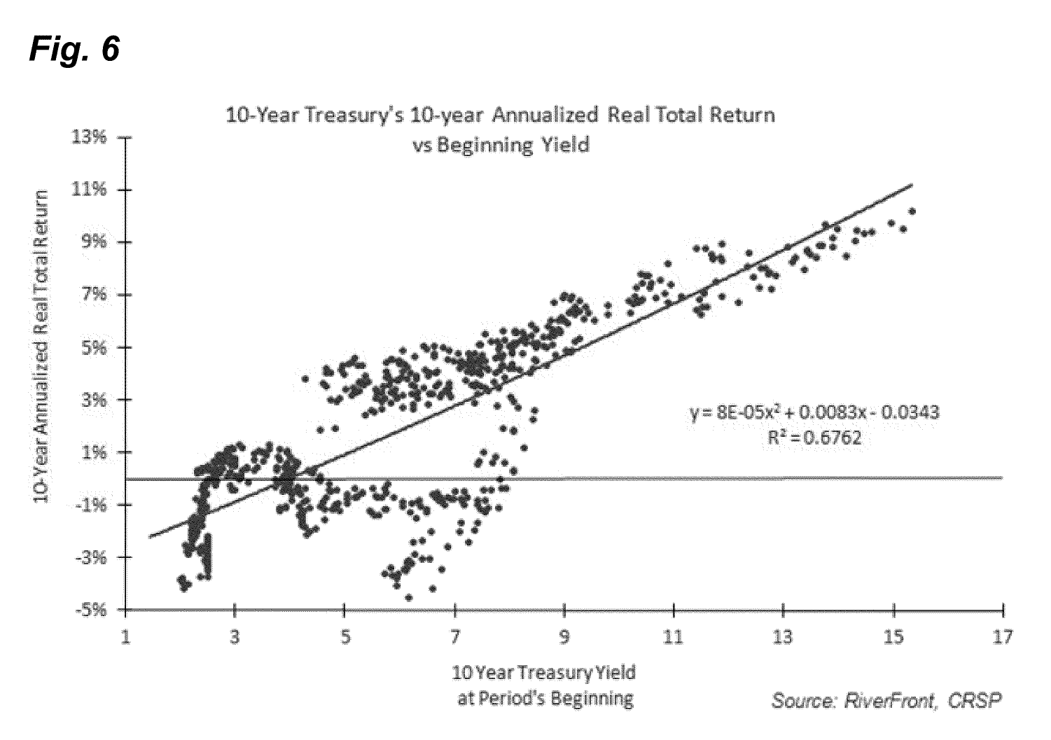

FIG. 6 Further illustrates the impact of starting yield on fixed income returns by charting real returns against the starting yield, with different inflation environments experienced during the investment reducing nominal returns. This characteristic of bond market returns is replicated with the Mean Reversion Optimization device.

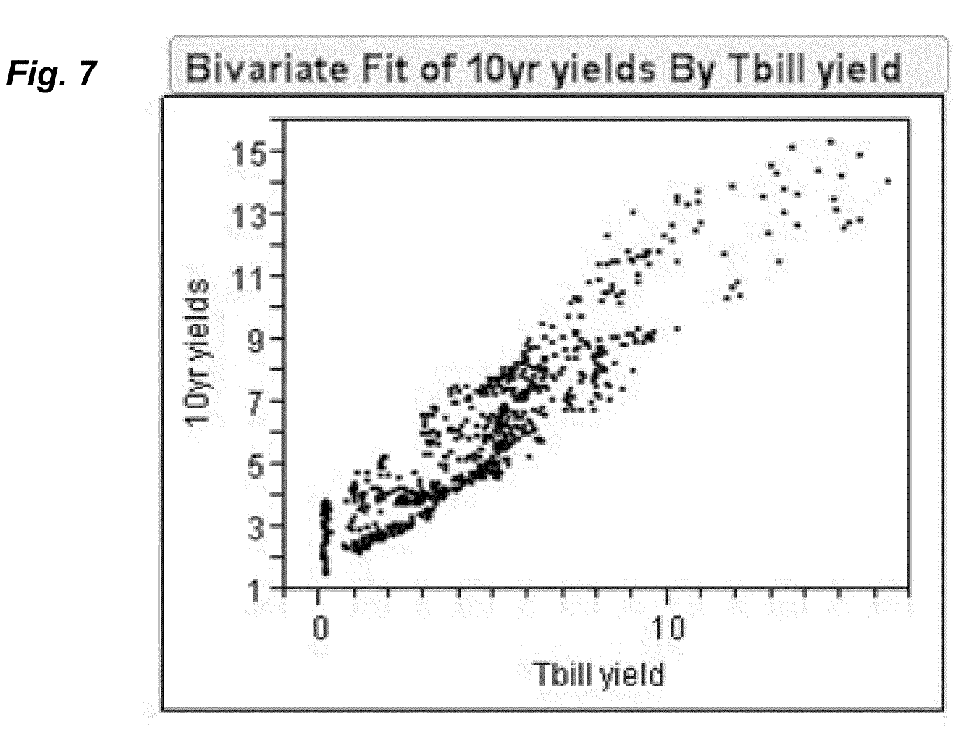

FIG. 7 is a graph of the relationship between short interest rates, which are predominantly determined by Federal Reserve policy, and yields on 10-year maturity treasury bonds which are anchored by the Fed determined short rates. This anchoring to Fed policy cannot be reflected in random walk implementation processes, and is essential for accurate asset allocation decisions during periods such as now when the Fed has committed to a certain interest rate target for an extended period of time.

Existing yield curve models (e.g., Cox, Igersoll & Ross; Black Derman Toy; etc.) and simulations based upon these models are typically used for price fixed income instruments and in this application the rates must be “tuned” to adhere to arbitrage free conditions. At its simplest, arbitrage free conditions assure that if currently traded risk free bonds are priced through the interest rate model, then the calculated price will closely approximate actual market prices. This condition applies both for bonds priced back to the analysis date or at some future date.

Although tuning to arbitrage free conditions is known for interest rate models, conventionally, these models have not been used to determine optimal asset allocation, but rather to compare the prices of competing bonds to determine potential investment opportunities through over or undervalued securities. Because the asset allocation optimization process focuses on future values rather than current values, the analyst must decide whether the assumptions imposed by arbitrage free conditions are desirable within an asset allocation framework. In an upward sloping yield curve environment, for example, arbitrage free conditions typically impose a pronounced upward drift to future interest rates and therefore tend to bias fixed income future values downward. In some applications, and for some investment purposes, the analyst may want to maintain the comparability of arbitrage free modeling and may want to see asset allocation results without this implicit bias. To this end, the asset allocation system can enable an option with arbitrage free conditions.

Assumed returns for fixed income asset classes preferably include an assumption regarding the market risk premia, or yield spread, over treasuries specific to that asset class. Historically, these risk premia can include, but are not limited to, the inflation rate, interest rate environment, steepness of the yield curve, and returns within equity markets. Since these inputs are endogenous to the simulation, models for risk premia for various asset classes can be developed and implemented in the computer system. The unexplained variation of risk premia can be added to model output through a Monte Carlo process. Similarly, credit sensitive fixed income asset classes can be simulated as a function of variables endogenous to the simulation and a random component simulated using Monte Carlo methods.

The difference between a current value of an asset class with a trend line of the historic values of that asset class can be used to estimate, or indicate, an expected asset class future value and the volatility in future values of the asset class after certain investment periods. The interest rate environment, on the other hand, provides similar investment characteristics for fixed income asset classes. The expected future value and the volatility for an asset class can be estimated by the response of the asset class in other periods with, for example, similar asset class valuation, interest rates, and inflation. From the historical data, a distribution of asset class future values can be calculated by a computer implemented modeling software or other computer implemented method.

The distribution of asset class future values indicates the probability that the value of an asset class, including interim cash flow, will rise and fall and the extent of the rise and fall historically. In this regard, the definition of “risk” can be redefined more clearly as chance of not meeting an investment goal within a particular investment horizon. An investment horizon can be defined at the a future time when the money in an investment is expected to be needed including, for example and not limitation, at retirement, for college tuition, purchase of a second home, or other financial need. The distribution of future values can indicate the lowest potential movement of the asset class, the highest potential movement, and an expected, or “normal,” movement of the values based upon the historic responses to a difference from the trend line.

This distribution can be used to determine an investment strategy, including the percentage of the value of an investment portfolio that should be allocated to that asset class, assuming periodic rebalancing back to the targeted percentage. If the method is performed for a plurality of asset classes, the estimated future values and the potential volatility of each class can be used to develop a strategic asset class allocation for an individual or group of investors based upon their specific needs, including the desired investment period.

Embodiments of the present invention preferably look beyond the multi-month fluctuations inherent in financial markets and develop a long-term, multi-cycle forecast of potential returns and risks for the major asset classes. The model is preferably driven by initial market conditions (e.g., level of interest rates, distance from trend, etc.) and considers investment goals and investment horizons, among other things. These forecasts of risk and return can be incorporated into an optimization framework that calculates the combination of asset classes offering the maximum potential return for the accepted degree of risk. For a complete analysis, the analysis can be performed over various investment periods. The appropriate investment periods can be determined by the investment horizon and, in some cases, will include the investment horizon and at least one additional investment period. The risk can then be determined by comparison of the analysis for each investment period.

As used herein, “asset class” can include a category of potential investment vehicles including, but not limited to, cash. Cash can include, for example, money market funds and bonds. Bonds can include, for example, investment-grade bonds, “junk” or high-yield bonds, government bonds, corporate bonds, short-term bonds, intermediate term bonds, long-term bonds, domestic bonds, foreign bonds, and emerging markets bonds. Stocks can include, for example, value or growth stocks, large capital stocks, small capital stocks, public equities, private equities, domestic, foreign, and emerging markets. Investment vehicles can also include real estate, real estate investment trusts, foreign currency, and natural resources. Natural resources can include, for example, oil, coal, cotton, and wheat.

Other investment vehicles can include, for example, precious metals and collectibles. Collectibles can include, for example, art, coins, or stamps. Investment vehicles can also include, for example, insurance products including, for example, life settlements, catastrophe bonds, and personal life insurance products. These investment vehicles can be further categorized into additional asset sub-classes such as, for example, by size (e.g., large capital, mid capital or small capital), or by style (e.g., by growth, income, or a combination thereof). As used herein, a “Large Capital” or “Large Cap,” for example, is a company having a total market capitalization of over ten billion dollars.

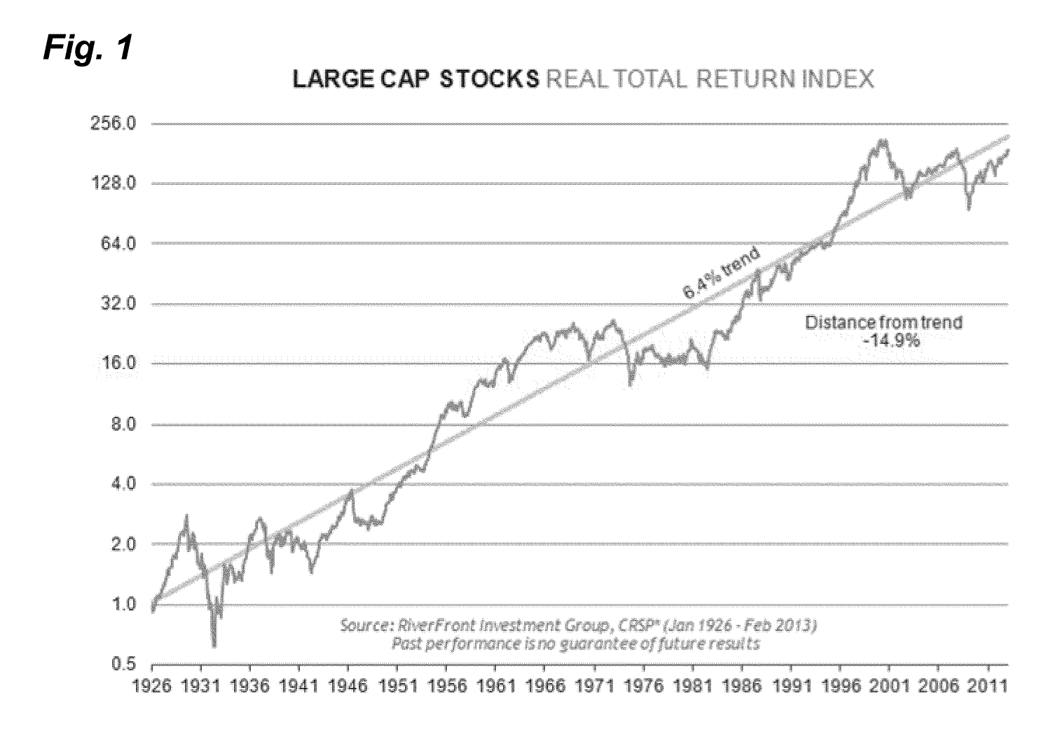

Conventionally, asset allocation strategies have been developed assuming that markets and asset classes respond according to a random walk theory. However, analysis of historical asset class returns on investment suggests that a random walk theory is correct only over extremely short or extremely long investment horizons, not over a typical investment period for an investment portfolio. Over one year periods (as typically used in conventional asset allocation strategies), for example, market returns do appear to be almost completely random, as the interplay of investors' emotions such as fear and greed, outweigh valuation considerations. As exemplified by a graph of the historic values of Large Cap stocks in FIG. 1, however, asset classes consistently provide returns fairly close to the long-term average over long investment periods such as, for example, thirty or forty years. The trend line on FIG. 1, for example, shows a 6.5% increase in value of large cap stocks over a long period of time. Typical investors may have investment goals that need to be met in shorter time frames, however, such as 5, 10, or 20 years. This can be because funds are needed for children's college education costs or money for retirement, among other things. Over these longer time horizons, investment returns are neither completely random nor necessarily consistent with the long-term average returns. For three, five, and ten year investment periods, for example, the interest rate for fixed income instruments and the distance from the long term trend at the start of the investment period has a strong influence on subsequent investment returns. Over these intermediate time periods the historical tendency of markets to revert to their long term trend (e.g., for large cap stocks, the 6.5% long term trend line) provides a strong influence on returns. For fixed income asset classes, these intermediate time frames give sufficient time for the impact of price changes to be offset by changes in reinvestment rates, for example, resulting in fixed income returns reverting toward the starting yield. Rising rates, for example, typically result in capital losses, but also tend to provide higher reinvestment rates. Mathematically, over a long enough holding period, the higher reinvestment income tends to offset some, or all, of the capital loss.

Thus, fixed income asset class returns on investment tend to revert toward the initial nominal interest rate of the asset class (adjusted for defaults), as opposed to the long term mean level of real return. The rate of reversion toward the starting rate varies greatly, however, depending upon the interest rate environment. Furthermore, since fixed income tends to revert to a nominal level of return, investor “real” returns over inflation are highly dependent on the rate of inflation experienced during the investment period. As a result, because the initial interest rate changes each period within the simulation, the reversion point also varies within each period.

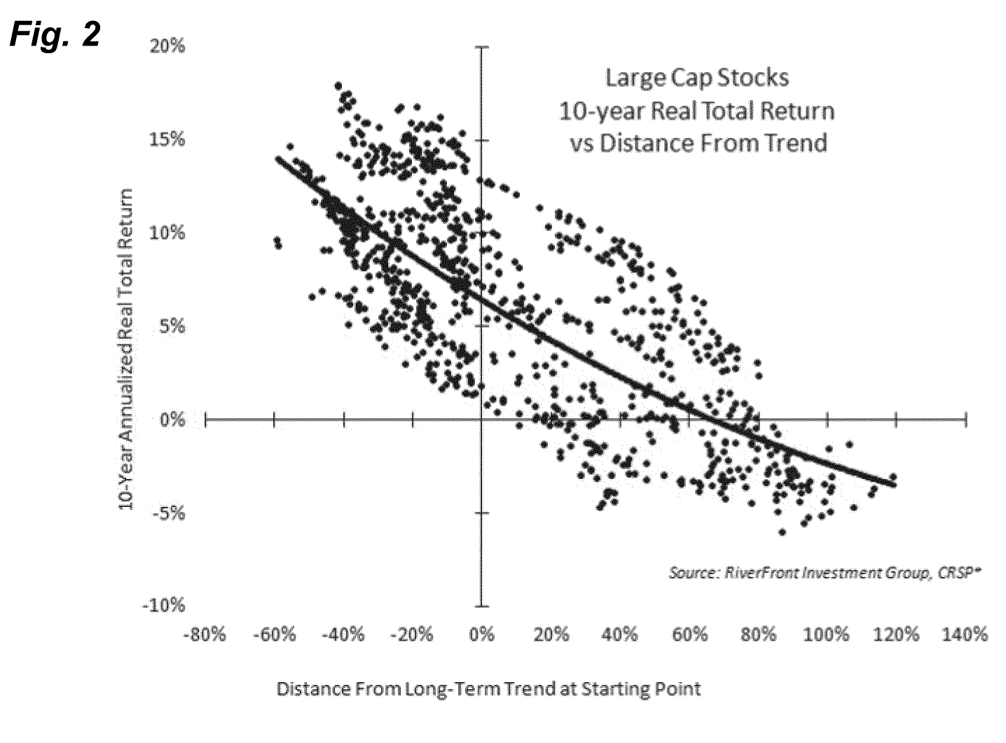

The evidence for this mean reverting tendency in financial markets is shown is in FIG. 2. FIG. 2 is a graph of the ten year return on stocks of large cap companies versus the distance from the long term trend line of large cap stocks at the beginning of the ten year return period, illustrating that the distance from trend at the beginning of the investment period has a powerful impact on subsequent returns not captured in random walk based asset allocation methodologies. Each point on the graph represents an observation for large cap stocks from a specific date (e.g., March 1926 or June 1968).

On the left side of the chart are observations from periods starting with large cap stocks trading below the long-term 6.5% trend line (i.e., prices were low), while the right side of the chart shows periods starting large cap stocks above the long-term trend (i.e., prices were high). The total return for each of these observations over the subsequent 10-year investment period is shown on the vertical positions on the chart—the higher up the chart, the greater the return. Analysis of the historical data shows that when prices start from well below the historical trend, 10-year returns have been above average. Conversely, periods that begin with above-average prices, i.e., values above the trend line, tend to produce below-average returns. This tends to show that markets exhibit a strong mean reversion tendency that is not reflected in conventional industry standard capital market assumptions and asset allocation optimization methodologies.

Embodiments of the present invention, therefore, can comprise a method for calculating regression equations from the historical data for a plurality of asset classes to determine a trend line. The current value of the asset class can be compared to this regression equation, or trend line, to determine the difference between the expected value based upon the regression analysis and the current value. In some embodiments, the method can also comprise calculating a distribution of future values. This can enable the calculation of expected future values of the asset class and/or an expected return and potential volatility of the investment class from the current valuation for one or more investment periods. This calculation is closely tied to historical data because the distribution is based upon historical responses of the asset class to the difference between the current value and the expected value, as provided by the trend line. The average 1-year, 3-year, 5-year, 7-year, and/or 10-year returns produced by the asset class, for example, at each difference can be observed in the historical data. In some embodiments, to calculate CMAs, the distance above or below the trend line for a particular asset class can be calculated and input into the regression equation.

FIG. 1 depicts the real total return of the stock of large cap companies over a period starting in the year 1926 and ending in the year 2013 and illustrates the tendency of asset class values to revert back to the long term trend over long investment horizons. This tendency for the market value to revert to trend results in consistent market return patterns, with periods starting below the long term trend characterized by above trend returns and periods beginning below the long term trend characterized by below trend returns. This consistent market behavior is not reflected in industry standard asset allocation techniques.

As shown in FIG. 1, for example, the large cap market in 2010 was about 20% below its long-term trend line. Using this difference in the regression equations indicates that the average return for the historical observations is about 8% above inflation. In other words, absent other considerations beyond historical mean reversion such as the inflation and interest rate environment, investors are likely to experience above-average returns in large-cap stocks for an investment period of 10 years from this starting point.

Even if CMAs are calculated using mean reversion concepts, however, the value of these calculations is somewhat nullified by applying them within a standard mean variance optimization (MVO) or resampling approach to turn these CMAs into usable asset allocation strategies. The challenge in such a mixed approach is that the inputs within MVO or resampling are typically based on one period (typically 1-year) time frames, a time frame too short for mean reversion to exert much influence. Even when applied within a multi-period simulation process, the standard optimization approach typically does not adjust the CMA inputs to reflect the outcomes of a particular trial. Assuming a below trend starting point, for example, a simulation trial resulting in large negative returns for large cap stocks will increase the asset class distance under its long term trend. By going further below the long term trend, history suggests that the longer term future return potential of the asset class is improved and its downside risks at longer investment horizon are reduced. MVO or resampling, however, do not provide for dynamic CMAs that adjust based upon the outcomes within a particular trial in the simulation. As a result, while mean reversion is incorporated into the initial inputs to the optimization, it is not adjusted appropriately during the optimization itself.

Embodiments of the present invention can include optimizations conducted using Monte Carlo-type methods. Generally, Monte Carlo methods are a class of analytical techniques using computational algorithms that rely on repeated random sampling to compute their results. Monte Carlo methods are often used in simulating physical and mathematical systems. These methods are more suited to calculation by a computer and tend to be used when it is infeasible to compute an exact result with a deterministic algorithm.

Monte Carlo methods are useful for simulating systems with many coupled degrees of freedom, for example, such as asset allocation strategies for investment portfolios. Monte Carlo methods vary, but tend to comprise the same steps, defining a domain of possible inputs, generating inputs randomly from a probability distribution over the domain, perform a deterministic computation on the inputs, and aggregate the results. Using embodiments of the present invention, however, the domain of possible inputs is the distribution of expected returns developed from the aforementioned difference from trend and starting rate analysis. The Monte Carlo method can be performed for portions of the investment period or for the entire the investment horizon. In either case, the method can comprise recalculating the domain of possible inputs or the distribution of expected returns based upon the new distance from trend or interest rate of the asset class resulting from the first iteration. Thus, the capital market assumptions are not static throughout iterations of the Monte Carlo method but can be variable based upon the outcome of the previous iteration. Capital market assumption may comprise, for example and not limitation, expected return at a future date, asset class volatility, and asset class correlations.

As an added improvement to typical Monte Carlo methods, however, and as opposed to the standard convention of assuming static correlations between asset classes, in some embodiments, the correlations between asset classes can also be varied during the simulation based on observed historical behavior. During typical market conditions, for example, the correlation between high yield bonds and large cap stocks is approximately 0.5. During sudden declines in the large cap market or sudden bear market declines, however, this correlation between the value of high yield bonds and large cap stocks rises to approximately 1.0. Under these same market conditions the correlation between large cap stocks and longer term treasury bonds approaches −1.0. Thus, embodiments of the present invention can include a “crises mode” that causes the correlations between asset classes to vary sharply from long term average inputs under certain simulation outcomes. In addition, less dramatic but still significant changes in correlation have occurred historically due to inflation rates, the interest rate environment, relative valuation levels between asset classes, and other factors. Thus, the method improves upon industry standard methodologies by allowing all CMAs (e.g., expected return, downside risk, and correlation) to vary within the simulation based upon starting conditions and the simulated outcomes within each trial.

Furthermore, the concept of mean reversion is inherently inconsistent with standard deviation of historical returns as the sole measure of risk. As shown in the inset of FIG. 1, in the late 1990s the smooth, steady ascent of equity prices reduced the standard deviation of returns and, therefore, risk as measured by conventional industry standard practices. Under mean reversion concepts, however, risk was steadily increasing over this period as markets climbed further and further above their long term trend. The converse situation was observed in early 2009, as highly volatile markets in the wake of the financial crises elevated standard deviation levels at the same time that measures of distances from trend suggested that risk was rapidly declining. Thus, to reflect mean reversion concepts the optimization process must go beyond standard deviation of returns as a measure of risk for equities and commodities.

Similarly, historical returns from fixed income asset classes show that the starting interest rate has a profound impact on longer term downside risks, risks that cannot be captured by the standard deviation of shorter term returns. Shorter term return volatility increases at lower interest rate levels (all else being equal) due to the mathematical relationship between the level of interest rates and the price volatility of the bond (usually measured by the bond's “duration”). This relatively small increase in price volatility (standard deviation), however, does not adequately capture the increase in longer term downside risk evidenced in the historical data. Equity and commodity asset classes tend to revert toward a long term trend “real” return, a return over and above the observed rate of inflation. Fixed income asset classes, on the other hand, tend to revert toward the starting nominal yield and observed inflation must be subtracted to calculate real returns. Low interest rate environments mathematically lead to low nominal returns leading investors to accept substantial downside to the inflation adjusted value of their portfolio should inflation rates rise. To reflect the impact of starting interest rates on downside risks, therefore, the optimization process must go beyond standard deviation of returns as a measure of risk for fixed income asset classes.

Embodiments of the present invention and the optimization process described herein address these shortcomings of the prior art. As detailed below, mean reversion optimization can utilize a multi-period simulation of potential returns. Potential returns can be calculated based upon the distance from the trend line for equities and commodities and starting interest rates for fixed income at each time step in the simulation. The simulation of potential returns extends beyond industry standard techniques by enabling correlations between asset classes to spike during market crises, “black swan” downside risks, and other assumptions that more accurately reflect actual historical market behavior. As used herein, a “black swan” is an event that lies outside the realm of regular expectations. As a result, they are difficult to predict and have an extreme impact. In some embodiments, therefore, the method can utilize a definition of risk that goes beyond one period standard deviation of returns and can look at portfolio valuations at multiple forward points in the simulation, incorporate mean reversion tendencies into the risk assessment, and enable the investor's time horizon to be explicitly incorporated into risk calculations.

Mean reversion optimization (MRO), as with traditional techniques, seeks to optimize the potential return of the portfolio subject to a specific level of risk. Embodiments of the present invention, however, can define risk differently than conventional industry standard approaches. Traditional optimization techniques measure risk exclusively as volatility—the standard deviation of historical market returns. These traditional tools typically seek to build an asset allocation that offers the highest potential 1-year return for the amount of volatility (risk) assumed. Such a measure of risk assumes markets that are normally distributed. Markets tend to produce large losses (greater than 3 standard deviations from the mean), however, more often than would be expected from a truly normally distributed process. Such a measure of risk also assumes that correlations between asset classes are relatively fixed. In practice, however, correlations tend to be highly variable and the level of correlation tends to be highly dependent upon the market environment. Correlations across most asset classes, for example, tend to increase in extremely volatile markets.

The methods of mean reversion optimization used herein, on the other hand, can define risk the way investors do—as the probability of losing money—typically at the investment horizon. The probability of losing money for each asset class can then be determined by a simulated range of outcomes at each time horizon that approximates the historical experience for periods beginning at the current difference from the trend line. By ensuring that simulated returns approximate historical outcomes, this process ensures that “fat tailed” returns beyond those considered by MVO occur within MRO in approximately the same proportion as “black swans” have been observed historically. As used herein, a “fat tailed” distribution is a distribution that has a rounder peak and is weighted more heavily on one tail, which tends to indicate the increased chances of a loss in the asset class than a normal distribution. The simulation further improves upon industry standard techniques by assuming that markets periodically go into “crises mode,” during which correlations between asset classes will approach historical maximums or minimums depending upon observed historical behavior. The optimization process seeks the combination of asset classes with the highest potential return subject to a low probability of loss across investors' specific investment horizon.

Thus, the definition of risk can combine, for example and not limitation, volatility, time horizon, fat tail events, correlation spikes, and valuation levels into a single risk metric. In modeling risk within MRO, for example, the first step can be to ensure that the simulation allows for a higher probability of large losses (black swans) than is contained within a normal distribution. To accomplish this, the MRO Monte Carlo simulation can employ random numbers within the historic distribution that have been computed with “fat tails” that approximately correspond to the number of 4 and 5 standard deviation events observed in the historical record. Real returns from historical data can be used within a non-parametric distribution fitting process and/or Pareto distribution. This fitted distribution can provide pseudo random numbers within the simulation that produce fat tailed events that approximately match the historical experience.

A further dimension of risk that cannot be assessed in traditional optimization methods is the investment horizon. Higher volatility asset classes can serve up substantial declines over shorter investment periods. Mean reversion suggests that over longer investment horizons, however, painful declines tend to be somewhat offset by positive returns. As a result, investors with the ability to remain invested for longer time frames generally have a higher probability of receiving these offsetting positive returns. Fixed income asset classes have a mathematically driven tendency to revert to the initial nominal starting yield, as price changes are eventually offset by changes in reinvestment rates. In addition, since fixed income asset classes tend to revert toward a nominal return level, over longer investment horizons, real returns will be increasingly impacted by the rate of inflation. Traditional tools can only roughly approximate how different time horizons may equate to different levels of portfolio volatility. Since the probability of mean reversion (either positive or negative) rises with time horizon, however, MRO explicitly incorporates time horizon into the assessment of risk and thus, can optimize the combination of asset classes subject to a specific investment horizon.

Once time horizon is incorporated into the measure of risk, the distance from long term trend can also be incorporated. This is desirable because over longer term horizons overvalued asset classes are more likely to fall in value, and fall farther, than lower priced alternatives. For equities and commodities, for example, asset classes close to the maximum distance below the trend observed in the past could be viewed as having a lower than average risk level. This is logical because the historical record suggests positive returns are more likely than negative ones, provided the investors' time horizon provides for sufficient time for mean reversion to take effect.

By contrast, bonds with the lowest interest rates seen in the historical record can be viewed as having elevated downside risks. A low starting interest rate limits price appreciation since rates do not typically fall below zero. Thus, investors face a higher probability of price declines than price gains during periods of extremely low interest rates. These price declines can be offset through higher reinvestment income over time, but a low starting interest rate can greatly increase the amount of time required for higher reinvestment rates to offset price declines. Furthermore, the low nominal return in this situation increases the risk that rising inflation could offset real returns over longer investment horizons. Advantageously, while conventional standard deviation methods do not capture this elevate risk, MRO does.

By accounting for mean reversion tendencies in equity and commodity asset classes and the impact of initial interest rates on fixed income, among other things, MRO can better match the asset allocation strategy to the investment horizon of the investor. The appropriate amount of equities, for example, can be represented by an interaction between the distance from trend of the asset class and the time horizon of the client. This improves upon the industry standard method of measuring portfolio risk and setting portfolio allocation primarily as a function of shorter term portfolio standard deviation.

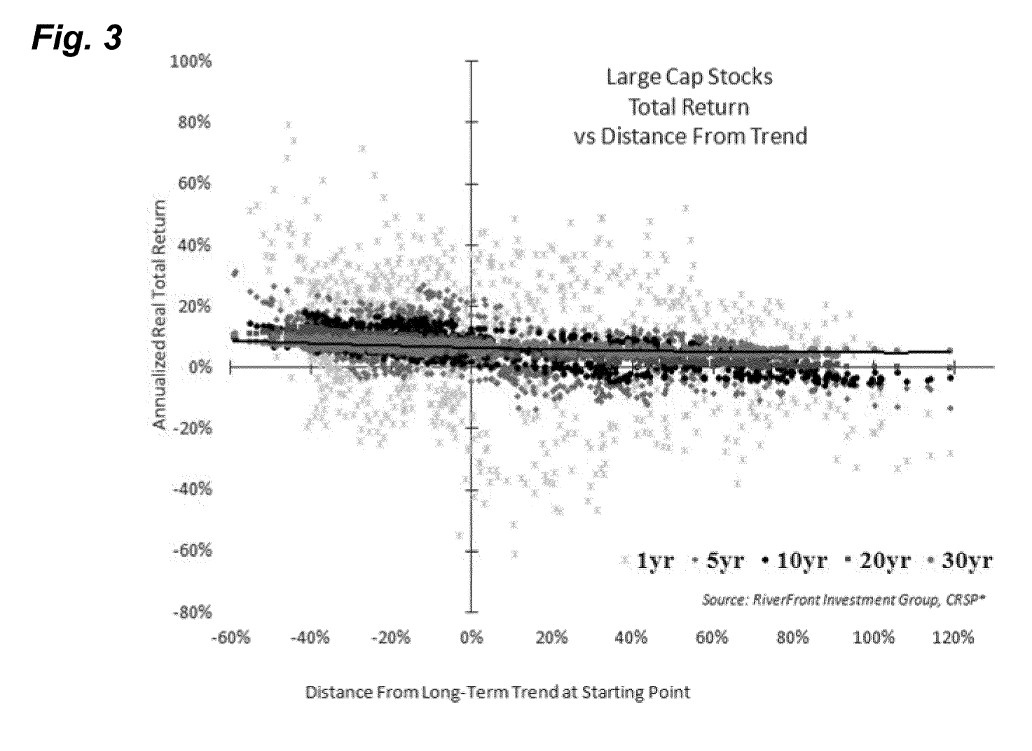

FIG. 3 is table comparing the relationship between starting distance from trend and subsequent Real Total Return distributions for large cap stocks across five investment periods including one year, three years, five years, seven years, and ten years for initial period. Data is provided for periods when the large capital stock asset class was at various starting distance from trend levels, beginning at 45% below trend and working up to very overvalued levels of 75% above the long term trend.

FIG. 3 shows real returns for large cap stocks across multiple investment horizons (1, 3, 5, 10 and 30) plotted against their beginning distance from trend. The chart illustrates that at very short investment horizons equity returns are highly variable irrespective of beginning distance from trend. As the investment horizon lengthens the variability in annualized returns declines as a function of mean reversion, with the average return experienced powerfully impacted by the beginning distance from trend. At the outer extremity of investment horizons, returns increasingly approximate the long term trend return as longer investment horizons reduce the impact of the starting valuation environment. This complex asset class behavior (essentially random at very short horizons of 1 year or less, mean reverting toward an average return determined by the starting distance from trend at intermediate horizons of 3 to 20 years, and approximating the long term trend at very pong horizons of more than 30 years) is not captured by existing asset allocation methodologies but is precisely replicated in the formula driving the Mean Reversion Optimization device.

FIG. 3 shows the expected returns and volatility from all historical periods that began with large cap stocks priced approximately 25% above the long-term trend line value. As shown, Large Cap stock reached a value of 25% greater than the trend line, for example, near the peak of the market in the fall of 2007. The bars at each investment period reflect all historical periods that began with valuations close to this difference of about 25% above the long-term trend. The chart shows that the probability of experiencing severe 1-year declines (or substantial gains) is primarily a function of asset class volatility. Whether the market is 25% over or undervalued does not change the distribution range of 1-year returns appreciably. Thus for short time periods the volatility of an asset class is by far the most important measure of risk. Lower volatility asset classes, such as investment grade U.S. bonds, for example, have never produced such short term losses. As the time horizon lengthens, however, valuation levels (price) become more and more important in measuring overall investment risk.

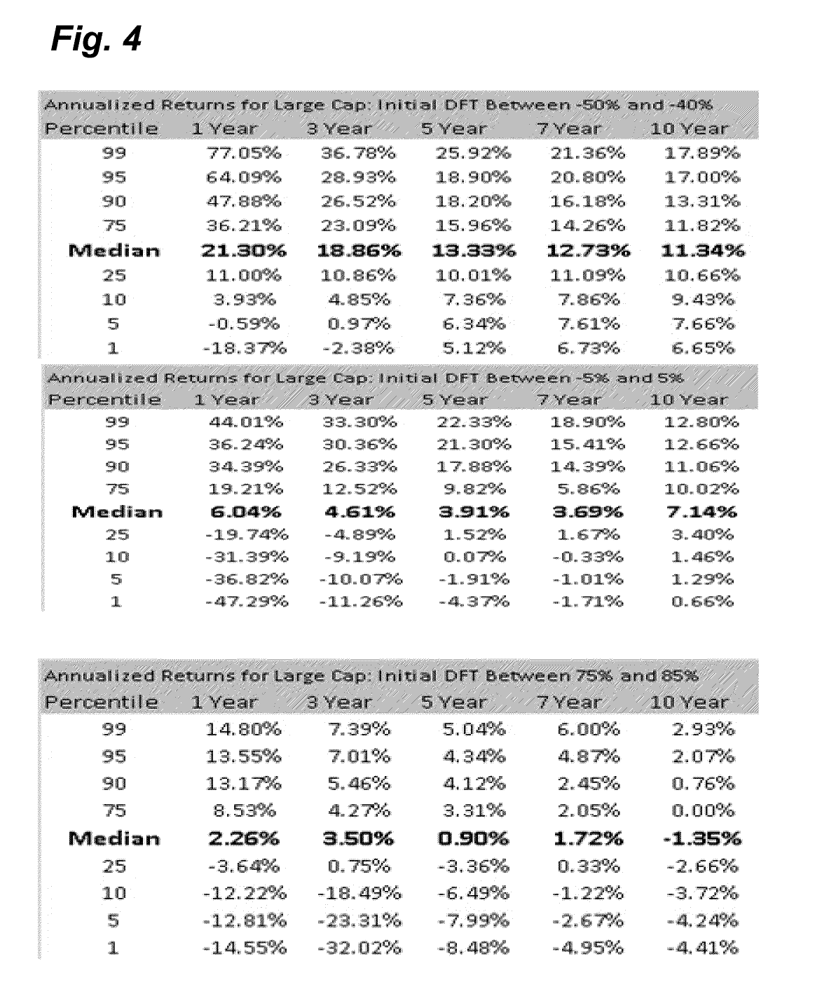

FIG. 4 is table comparing the relationship between starting distance from trend and subsequent Real Total Return distributions for large cap stocks across five investment periods including one year, three years, five years, seven years, and ten years for initial period. Data is provided for periods when the large capital stock asset class was at various starting distance from trend levels, beginning at 45% below trend and working up to very overvalued levels of 75% above the long term trend. Formulas within the Mean Reversion Optimization device reproduce this behavior for the unique distribution patterns of every asset class in the simulation.

History shows the potential for declines of up to 45% over a 1-year period when the market is priced at 25% over trend. Large cap stocks came very close to experiencing such a decline in the crash of 2008/early 2009. The lowest three-year recorded annualized return for comparably priced markets, however, has been a loss of about 18%. In other words, market returns for the two years subsequent to the 45% decline were slightly positive even in the worst periods of market history. In addition, the odds of offsetting positive returns increases significantly over five years (e.g., worst-case returns of about −10%) and still more at the 7- and 10-year horizons. Because the odds of a big loss decrease significantly over longer investment periods, time horizon has a significant impact on risk.

Price also has a significant impact on risk. For periods that began 25% above the long-term trend, for example, even investors with a 10-year investment horizon face little better than a 50/50 chance of making money. Contrast that with the green bars, which show returns for markets that began with levels of 25% below trend. Potential losses at the 1-year level are only slightly better than the overvalued market because emotion typically trumps price over shorter time periods. Worst-case losses at the 3-year period, however, are about half those of the overvalued markets, and by the 5-year horizon, downside risks are less than 3% per annum as compared to a potential upside of nearly 20%. As time horizons extend farther, the risk/reward benefits become even more favorable. For example, Large-cap equity markets have never produced a loss across a 10-year period that began with valuations 25% below trend.

Asset class volatility is preferably a part of any model of risk, because over shorter time frames these asset classes can experience larger losses. Buying at an attractive price offers little short-term protection (cheap asset classes can get even cheaper); however, the traditional focus on volatility as the sole measure of risk can cause critical investment mistakes. By not incorporating mean reversion, for example, the standard deviation of historical returns may underestimate risk by declining just as actual market risks are rising (and vice-versa). Furthermore, because traditional optimization techniques typically do not incorporate the investor's time horizon into the risk calculation, investors must guess what level of volatility is appropriate for their investment requirements. This can cause a loss of confidence in portfolio strategies that require sufficient time for mean reversion to have an impact on returns. As a result, investors can be lured into increasing risks during rising markets or decreasing risks after market declines. By incorporating time horizon and valuation into the model of risk, however, MRO provides a more comprehensive measure of risk, which can produce more suitable asset allocation solutions.

Embodiments of the present invention can comprise selecting the combination of asset classes that offers the highest potential return combined with low probability of loss across a specific investment horizon. The specific combination of asset classes that meets this low probability of loss test is highly dependent upon current valuation levels. An investor with a 3- to 5-year time horizon, for example, can accommodate a higher proportion of large cap stocks when that asset class is 25% below its long term trend than when (as in 2007) large cap stocks were 25% above trend. This is because the maximum loss experienced from this lower valuation level historically is much lower. As a result, the amount of low risk, low volatility, and/or low return assets can also be lower. Conversely, an investor with a 5 to 7 years investment horizon can accommodate a substantially higher allocation to large cap stocks than an investor with a shorter time frame, since the 2% to 3% maximum loss for large cap stocks over that time frame requires far less offset to provide a reasonable probability of a net positive return.

By defining risk as the probability of losing money and by incorporating price and time horizon into the calculation of risk, MRO can better align asset allocation strategies with a client's true risk tolerance as market conditions change. Should large cap stocks return to the 25% overvalued position of 2007, for example, the allocation to large cap stocks for both 3-5 year and 5-7 year investors would decrease significantly because the magnitude of potential losses at those time horizons would increase significantly.

The 1-year (or 1 period) assumption within traditional optimization techniques ignores the possibility that input assumptions might change in a multi-period framework. Because MRO explicitly models multi-period asset class returns, however, this methodology can provide for an evolution of expected returns and downside risks based upon the outcomes of specific trials within the simulation. Embodiments of the present invention can provide a method for asset allocation utilizing historical data to estimate expected average returns based on an initial distance from trend conditions. As the distance from trend values change along a particular simulation trial, these equations can be applied to vary expected returns and downside risks based upon the new valuation levels, which are dependent upon the previous outcome. The application of these equations within the simulation ensures that mean reversion concepts are applied throughout the simulation trial and not just in establishing initial market conditions. The accuracy of the simulation through the application of these equations can be checked and additional variance reduction techniques can be applied. In this manner, the term structure of volatility within the simulation approaches the historical record for each of the simulated asset classes.

With a robust measure of risk and a multi-period simulation of mean reverting and initial interest rate reverting returns, the final optimization process is extremely straightforward. The set of all asset class combinations that meet the criteria of low probability of loss at a specific time horizon is identified (the primary optimization constraint). The asset allocation solution is that combination of asset classes that meets this test (along with other, more subjective constraints such as asset class concentration), while offering the highest upside potential. Upside potential is measured as either the highest average return across the simulation or the highest absolute return, depending upon the preference of the analyst, and can include adjustment for inflation.

Embodiments of the mean reverting simulation may comprise selecting a first asset class, such as large cap stocks, as the basis, or “driver,” asset class for the simulation. In other embodiments, the simulation can be employ inflation, rather than an asset class, as the driver for the simulation. Inflation tends to show a definitive relationship to long term asset class returns and the tendency and speed of mean reversion. This historical relationship is generally too complex to express using standard Monte Carlo techniques (e.g., a covariance matrix, Cholesky decomposition, and separately calculated random movement).

In some embodiments, the method of asset allocation can comprise building the simulation using inflation as the driver and then calibrating simulated interest rates for various fixed income asset classes. The resulting fixed income return environments and distance from trend levels for equities and commodities can be combined with the inflation environment to create a more accurate simulation of real returns (i.e., returns over and above inflation). By simulating unprecedented inflationary environments and asset price relationships to inflation using historical data, MRO risk analysis can be extended to test the robustness of investment strategies to more extreme environments. Due to market safeguards, these environments have not been observed in the U.S., but that have nonetheless been relatively common in other world economies and markets.

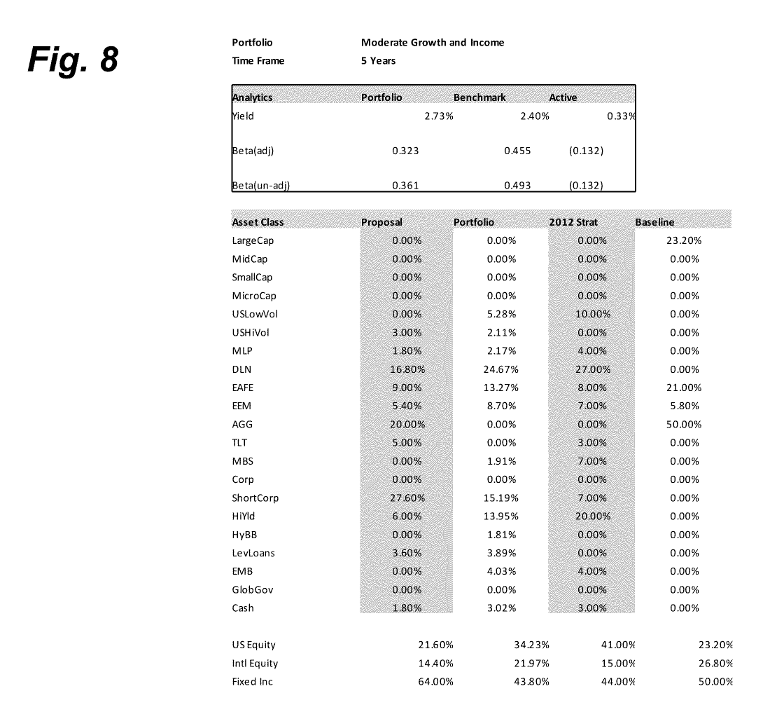

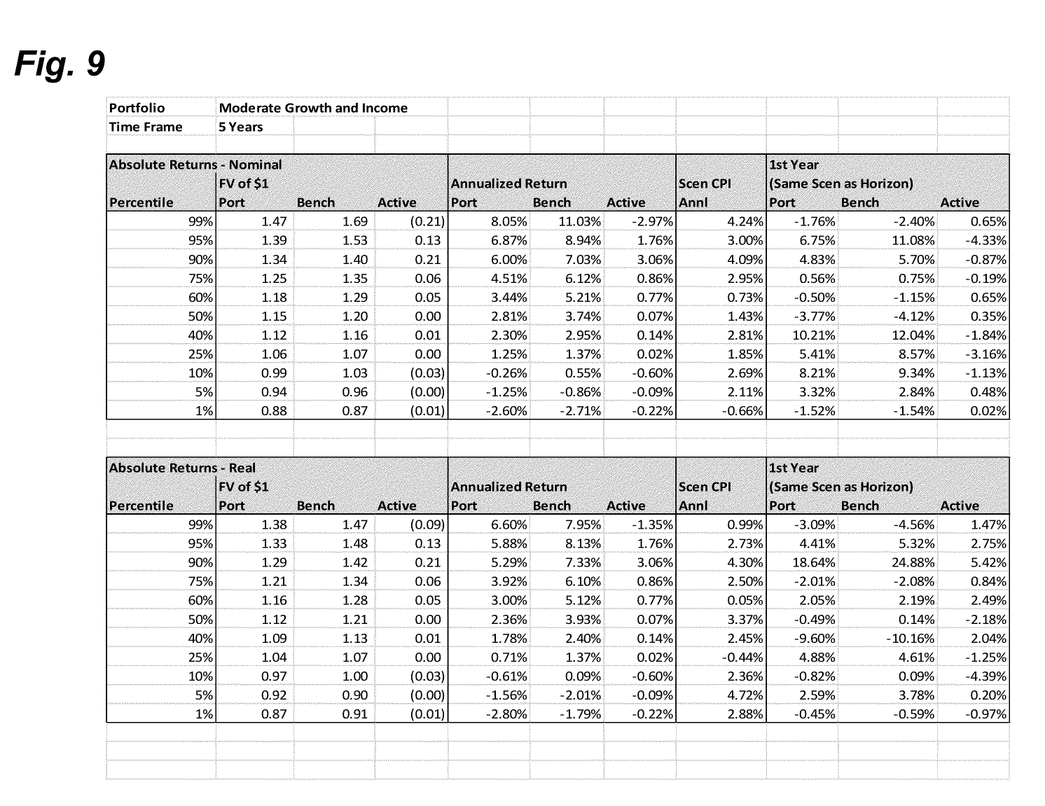

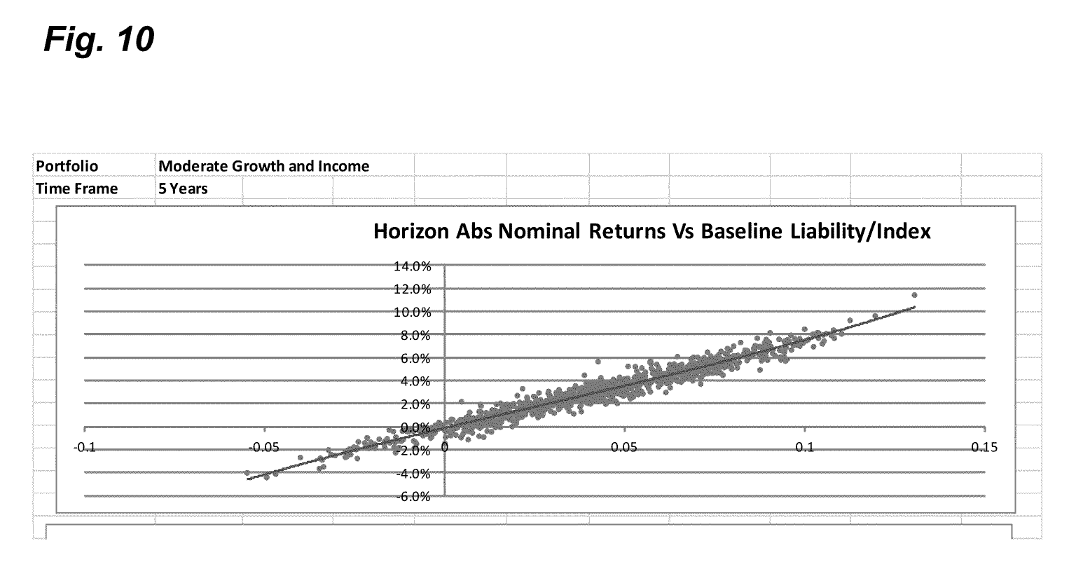

FIGS. 8-9 are examples of the output of the system, showing a recommended weighting in various asset classes, the associated portfolio future values at the investment horizon under multiple percentile return environments. FIG. 10 is a graph of the portfolio returns versus potential benchmarks/liabilities for all of the return environments in the simulation, illustrating the application of the Mean Reversion Optimization techniques in an asset liability framework.

While several possible embodiments are disclosed above, embodiments of the present invention are not so limited. For instance, while several possible configurations have been disclosed (e.g., asset class or interest rate based simulations), other suitable drivers and inputs could be selected without departing from the spirit of embodiments of the invention. In addition, the order of steps and configuration used for various features of embodiments of the present invention can be varied according to particular market conditions, asset classes, and/or investor or analyst preferences. Such changes are intended to be embraced within the scope of the invention.

The specific configurations, implementation, and the various elements used in simulation can be varied according to particular market environments or constraints requiring a device, system, or method constructed according to the principles of the invention. For example, while certain exemplary analyses have been provided, other methods and configurations could be used to, for example, minimize computer memory or processor usage. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A computer implemented method of setting an asset allocation strategy, comprising:
simulating one or more long term inflation environments using modified Monte Carlo methods using autoregressive tendencies from historical inflation data;
calculating an estimated distribution of interest rates for treasury obligations of one or more maturities;
calculating a difference between a current value and the current value predicted by a historic trend line of an asset class for one or more of equity and commodity asset classes; and
calculating an estimated distribution of equity and commodity asset class future values for one or more investment periods;
calculating an estimated distribution of risk premia over treasury obligation yields for various classes of fixed income instruments; and
estimating an estimated distribution of fixed income asset class future values for one or more investment periods;
wherein the expected asset class future values are calculated as a function of the starting yield of the asset class and the mathematical relationship between its future price and simulated changes in treasury interest rates and term risk premia over treasury rates for that asset class.

2. The computer implemented method of claim 1, wherein calculating the estimated distribution of equity and commodity asset class future values for one or more investment periods further comprises using a modified Monte Carlo method modified by the mean reversion of the respective equity or commodity asset class.

3. The computer implemented method of claim 2, wherein the estimated asset class future values are derived using one or more of:
historical responses of the asset class to the current difference from the historical trend line for each investment period;
the degree of mean reversion historically observed in each asset class;
the historical impact of the interest rate and inflation environment on the rate of mean reversion; and
a random component simulated by the Monte Carlo method calculations.

4. The computer implemented method of claim 1, wherein calculating the estimated distribution of fixed income asset class future values for one or more investment periods comprises using a modified Monte Carlo simulation of interest rates using one or more of:
Federal Reserve (the “Fed”) policy pronouncements;
the historical relationship between long term inflation and interest rates; and
a random component simulated by the Monte Carlo method.

5. The computer implemented method of claim 1, wherein the calculation of estimated distribution of interest rates for treasury obligations includes one or more of:
known future Fed interest rate policy;
the historical correlation between inflation rate, Fed policy, and longer maturity interest rates;
a random component simulated by Monte Carlo methods; and
the drift in future interest rates necessary to maintain arbitrage free conditions within the simulation; and

6. The computer implemented method of claim 1, wherein the calculation of estimated distribution of risk premia over treasury obligation yields includes:
the historical relationship between these risk premia and inflation;
the interest rate differential between treasuries of one or more maturities;
the returns of equity asset classes; and
a random component simulated by Monte Carlo methods.

7. The computer implemented method of claim 1, further comprising:
determining an investment horizon based upon investment goals;
wherein one of the investment periods is the investment horizon.

8. The computer implemented method of claim 1, further comprising:
setting an asset allocation strategy based upon the expected distributions of one or more asset classes.

9. The computer implemented method of claim 1, further comprising:
setting an asset allocation strategy by allocating a portion of the value of an investment portfolio into one or more asset classes based upon the expected asset class future value; and
resetting the asset allocation strategy on a predetermined basis.

10. The computer implemented method of claim 9, wherein the predetermined basis is an annual basis.

11. The computer implemented method of claim 2, wherein each Monte Carlo trial of the modified Monte Carlo method comprises a set of capital market assumptions; and
wherein the capital market assumptions of each subsequent Monte Carlo trial are recalculated based upon the results of a previous Monte Carlo trial, such that as an asset class moves away from the asset class long term trend, the capital market assumptions adjust to increase the probability of returning to trend in subsequent Monte Carlo trials.

12. The computer implemented method of claim 11, wherein the set of capital market assumptions for equity and commodity asset classes comprise one or more of:
expected return at a future date;
asset class volatility;
asset class correlations;
the impact of inflation on potential returns; and
the impact of interest rates on potential returns.

13. The computer implemented method of claim 11, wherein the set of capital market assumptions for fixed income asset classed comprise one or more of:
starting yield;
price volatility in response to changing interest rates (duration and convexity); and
a model of the asset classes term risk premia as a function of inflation, spread between yields on treasuries of one or more maturities and equity market returns.

14. The computer implemented method of claim 4, wherein each Monte Carlo trial of the modified Monte Carlo method for fixed income asset classes is modified as interest rates change; and
wherein higher interest rates indicate higher returns; and
wherein lower interest rates indicate lower returns.
